(19) United States
(12) Patent Application Publication
(10) Pub. No.: US 2009/0219230 A1
(43) Pub. Date: Sep. 3, 2009

(54) El Display panel module, el display panel and electronic apparatus

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/320,614

(22) Filed: Jan. 30, 2009

(30) Foreign Application Priority Data
Feb. 28, 2008 (JP) 2008-048257

(51) Int. Cl. G09G 3/30

(52) U.S. Cl. 345/76

(57) ABSTRACT

Disclosed herein is an electro luminescence display panel module, including: a pixel array section including a plurality of pixels, a plurality of signal lines extending in a vertical direction, and a plurality of horizontal lines extending in a horizontal direction, the signal lines and the horizontal lines being connected to the pixels such that each of the signal lines is connected to N ones of the pixel circuits which are connected to the same one of the horizontal lines, N being a natural number equal to or greater than 2; a first sampling control line; N second sampling control lines; a sampling scan driver; N pulse power supplies; and a horizontal selector; the pixel array section, the first sampling control lines, the N second sampling control lines, the sampling scan driver, the N pulse power supplies and the horizontal selector being mounted on the same substrate.

### CROSS REFERENCES TO RELATED APPLICATIONS

The present invention contains subject matter related to Japanese Patent Application JP 2008-048257 filed in the Japan Patent Office on Feb. 28, 2008, the entire contents of which being incorporated herein by reference.

### BACKGROUND OF THE INVENTION

1. Field of the Invention

This invention relates to a technique for optimizing the fabrication cost and the display image quality of an EL (electro luminescence) display panel which is driven and controlled by an active matrix driving method, and more particularly to an EL display panel module, an EL display panel and an electronic apparatus.

2. Description of the Related Art

A circuit block configuration popular to an organic EL panel module of the active matrix driven type is shown in FIG. 1. Referring to FIG. 1, the organic EL panel module 1 shown includes a pixel array section 3, and a sampling scan driver 5, a power supply scan driver 7 and a horizontal selector 9 which are driving circuits for the pixel array section 3.

Incidentally, an organic EL element is a current light emitting element. Therefore, the organic EL panel module adopts a driving method wherein the amount of current to flow through the organic EL element is controlled for control of the gradation of light to be emitted from each pixel. FIG. 2 shows one of comparatively simple circuit configurations for a pixel circuit of the type described. Referring to FIG. 2, the pixel circuit shown includes a sampling transistor T1, a driving transistor T2 and a storage capacitor Cs.

The sampling transistor T1 is used to write a signal voltage corresponding to a gradation of the corresponding pixel into the storage capacitor Cs. The driving transistor T2 is used to supply current Ids based on a gate-source voltage Vgs, which depends upon the storage voltage of the storage capacitor Cs, to an organic EL element OLED.

Incidentally, where the driving transistor T2 is formed from a p-channel type thin film transistor, it is connected at the source electrode thereof to a power supply line. In other words, the driving transistor T2 is designed so as to normally operate in a saturation region thereof. Accordingly, the driving transistor T2 operates as a constant current source. Thereupon, the current Ids is given by the following expression:

Ids=k·μ·(Vgs−Vth)²

where μ is the mobility of the majority carrier of the driving transistor T2 and Vth the threshold voltage of the driving transistor T2, and k is given by (W/L)·Cox/2. Here, W is the channel width, L the channel length, and Cox the gate capacitance per unit area.

It is to be noted that, in the configuration of the pixel circuit described, the drain voltage of the driving transistor T2 varies together with the aged deterioration of the I-V characteristic of an organic EL element illustrated in FIG. 3. However, since the gate-source voltage Vgs is kept fixed, the amount of current supplied to the organic EL element does not vary, and the luminance of emitted light is kept fixed.

An organic EL display panel which adopts the active matrix driving method is disclosed, for example, in Japanese Patent Laid-Open Nos. 2003-255856, 2003-271095, 2004-133240, 2004-029791 and 2004-093682.

### SUMMARY OF THE INVENTION

Incidentally, if the driving transistor T2 is replaced by an n-channel type thin film transistor, then it is connected now at the source potential thereof to the organic EL element as seen in FIG. 4. In the case of the present pixel circuit, the amount of current varies together with the aged deterioration of the I-V characteristic of the organic EL element, and the luminance of emitted light varies.

Further, since the threshold value and the mobility of the driving transistor T2 vary among different pixels, a dispersion appears in the current value in accordance with the expression given hereinabove, and also the luminance of emitted light varies for each pixel.

Therefore, it is demanded to establish a pixel circuit and a driving method by which a stabilized light emission characteristic is obtained regardless of the aged deterioration even where the driving transistor T2 is formed from an n-channel thin film transistor. Simultaneously, it is demanded to further decrease the fabrication cost in order to popularize the organic EL panel module.

According to an embodiment of the present invention, there is provided an EL display device including a pixel array section including a plurality of pixels disposed in a matrix and each including a pixel circuit and a light emitting region, a plurality of signal lines extending in a vertical direction and a plurality of horizontal lines extending in a horizontal direction, the signal lines and the horizontal lines being connected to the pixels such that each of the signal lines is connected to N ones of the pixel circuits which are connected to the same one of the horizontal lines, N being a natural number equal to or greater than 2, a first sampling control line provided in a unit of a horizontal line and connected to all of the pixel circuits connected to the horizontal line, N second sampling control lines provided for each one of the horizontal lines and connected in a unit of a group to N ones of the pixel circuits connected to each of the signal lines, a sampling scan driver for line-sequentially driving the first sampling control lines in a unit of a horizontal line, N pulse power supplies for driving all of the pixel circuits of the pixel array section in a unit of a group through the N second sampling control lines, and a horizontal selector for time-sequentially applying, upon writing of a signal potential, N signal potentials for the individual signal lines within the same period.

According to another embodiment of the present invention, there is provided an EL display device including a pixel array section including a plurality of pixels disposed in a matrix and each including a pixel circuit and a light emitting region, a plurality of signal lines extending in a vertical direction and a plurality of horizontal lines extending in a horizontal direction, the signal lines and the horizontal lines being connected to the pixels such that each of the signal lines is connected to those of the pixel circuits which are connected to different ones of the horizontal lines, a first sampling control line provided in a unit of a horizontal line and connected to all of the pixel circuits connected to the horizontal line, N second sampling control lines connected to all of those of the pixel circuits on one of the horizontal lines which corresponds to each of the groups, N being a natural number equal to or greater than 2, a sampling scan driver for line-sequentially driving the first sampling control lines in a unit of a horizontal line, N pulse power supplies for driving all of the pixel circuits of the pixel array section in a unit of a group through the N second sampling control lines, and a horizontal selector for time-sequentially applying, upon writing of a signal potential, N signal potentials for the individual signal lines within the same period.

The EL display devices are formed as devices of the current driven type and can implement both of reduction of the cost by reduction of the number of signal lines and reduction of the size of the driving circuit and assurance of high picture quality. It is to be noted that each of the EL display devices can be formed as an EL display panel module and an EL display panel.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a circuit block configuration of an organic EL panel module;

FIG. 2 is a circuit diagram showing an example of a pixel circuit;

FIG. 3 is a diagram illustrating aged deterioration of the I-V characteristic of an organic EL element;

FIG. 4 is a circuit diagram showing an another example of a pixel circuit;

FIG. 5 is a schematic view showing an example of an appearance configuration of an organic EL panel module to which an embodiment of the present invention is applied;

FIG. 6 is a block diagram showing an example of a system configuration of an organic EL panel module according to an embodiment 1 of the present invention;

FIG. 7 is a block diagram illustrating a connection relationship between pixel circuits and driving circuits of the organic EL panel module of FIG. 6;

FIG. 8 is a block circuit diagram of a form of a pixel circuit used in the organic EL panel module of FIG. 6;

FIGS. 9A to 9E are timing charts illustrating an example of driving operation for the pixel circuit of FIG. 8;

FIGS. 10 to 13 are circuit diagrams illustrating different operation states of the pixel circuit of FIG. 8;

FIG. 14 is a diagram illustrating aged deterioration of the source potential of a transistor;

FIGS. 15 and 16 are circuit diagrams illustrating different operation states of the pixel circuit of FIG. 8;

FIG. 17 is a diagram illustrating a difference in aged deterioration of a transistor arising from a difference in mobility;

FIG. 18 is a circuit diagram illustrating an operation state of the pixel circuit of FIG. 8;

FIG. 19 is a block diagram showing an example of a configuration of an organic EL panel module according to an embodiment 2 of the present invention;

FIG. 20 is a block diagram illustrating a connection relationship between pixel circuits and driving circuits of the organic EL panel module of FIG. 19;

FIGS. 21A to 21G are timing charts illustrating an example of driving operation of the organic EL panel module of FIG. 19;

FIGS. 22A to 22G are timing charts illustrating another example of driving operation of the organic EL panel module of FIG. 19;

FIG. 23 is a block diagram showing an example of a configuration of an organic EL panel module according to a different embodiment of the present invention;

FIGS. 24A to 24I are timing charts illustrating an example of driving operation of the organic EL panel module of FIG. 23;

FIG. 25 is a block diagram showing an example of a configuration of an organic EL panel module according to another different embodiment of the present invention;

FIGS. 26A to 26G are timing charts illustrating an example of driving operation of the organic EL panel module of FIG. 25;

FIG. 27 is a schematic view showing an example of an electronic apparatus; and

FIGS. 28, 29A and 29B, 30, 31A and 31B, and 32 are schematic views showing different examples of the electronic apparatus of FIG. 27 as a commodity.

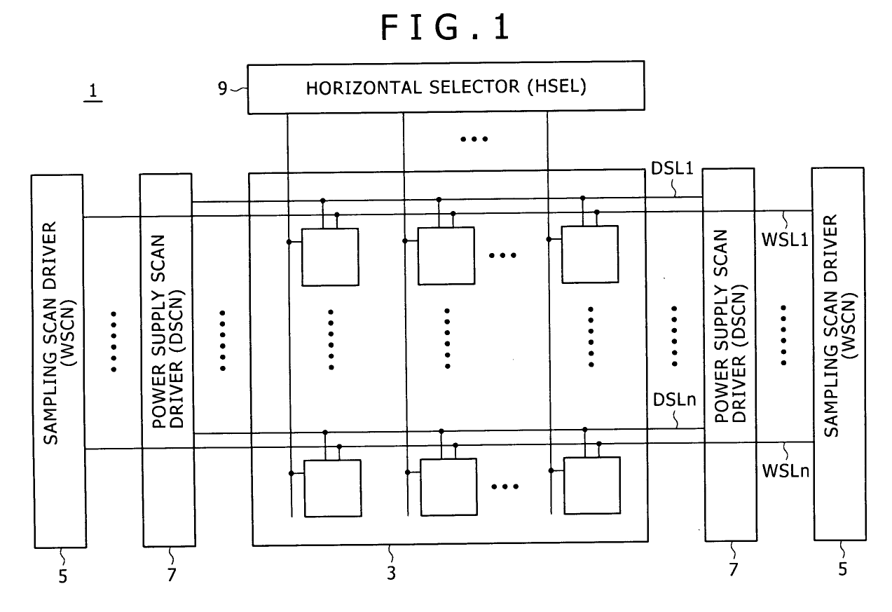

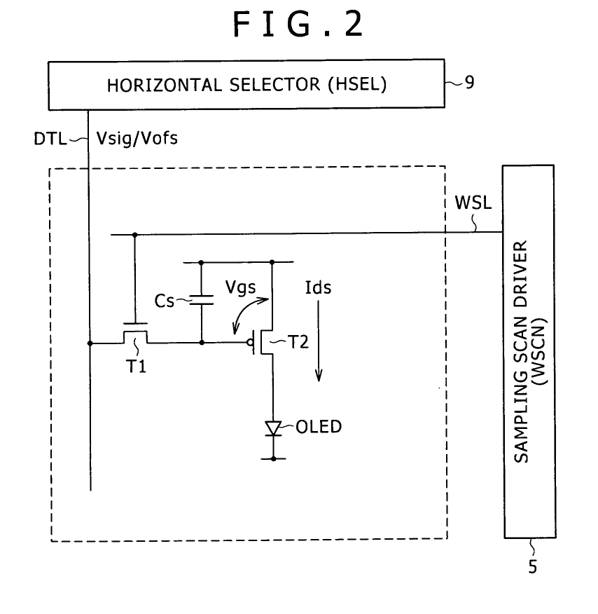

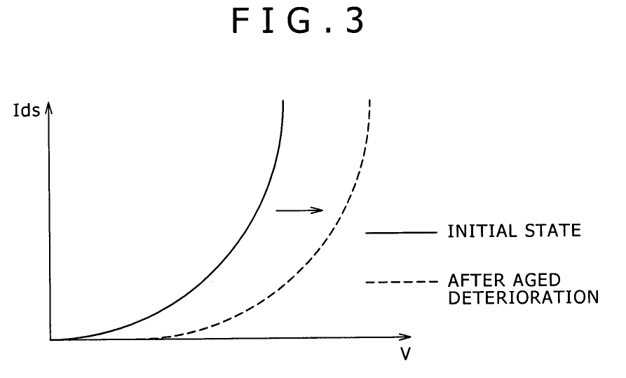

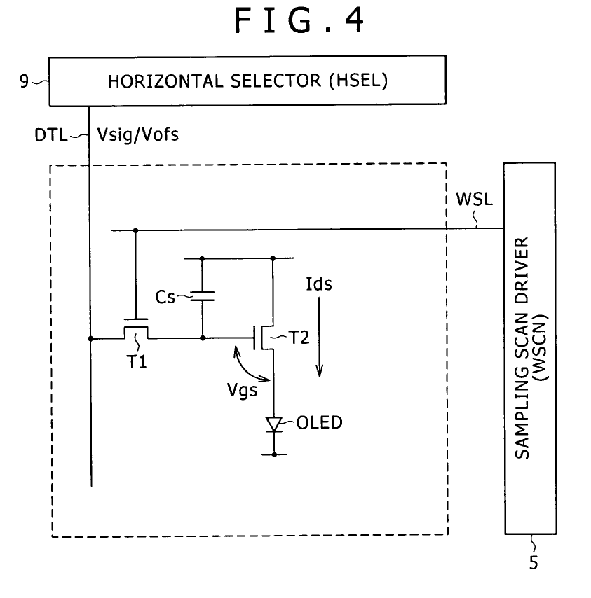

### DETAILED DESCRIPTION OF THE PREFERRED EMBODIMENT

In the following, the present invention is described in detail in connection with an organic EL panel module or an EL display panel of the active matrix driven type to which an embodiment of the present invention is applied.

It is to be noted that, for technical matters which are not specifically described herein or specifically illustrated in the accompanying drawings, techniques which are known in the pertaining technical field are applied.

### A. Appearance Configuration

In the present specification, an apparatus wherein driving circuits fabricated, for example, as ICs (integrated circuits) for a particular application are mounted on a board on which a pixel array section is formed is referred to as organic EL panel module, and an apparatus wherein a pixel array section and driving circuits are formed on the same substrate using the same process is referred to as organic EL panel.

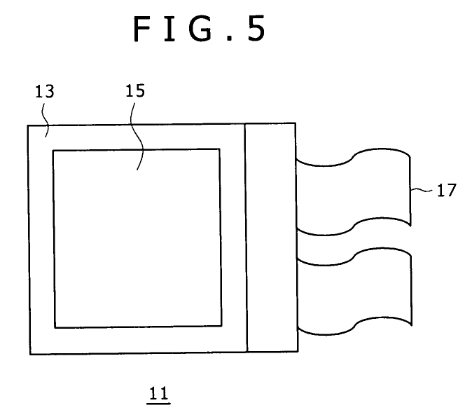

In the following, the organic EL panel module is described. FIG. 5 shows an example of an appearance configuration of an organic EL panel module 11. Referring to FIG. 5, the organic EL panel module 11 shown is structured such that an opposing section 15 is adhered to a region of a support substrate 13 in which a pixel array section is formed.

The opposing section 15 includes a substrate made of glass or some other transparent material and a color filter, a protective film and so forth disposed on the surface of the substrate. Further, flexible printed circuits (FPC) 17 for inputting and outputting signals and so forth from and to the support substrate 13 are disposed on the organic EL panel module 11.

### B. Embodiment 1

### B-1. System Configuration

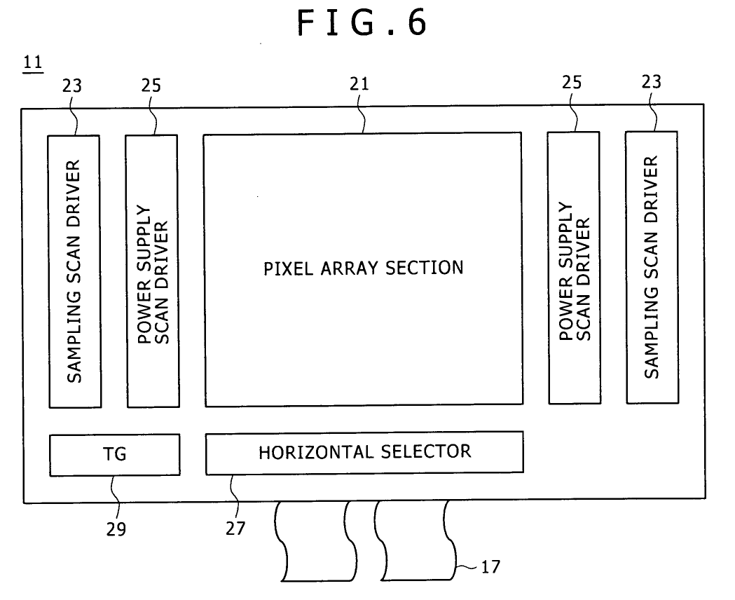

FIG. 6 shows a general system configuration of the organic EL panel module 11 according to an embodiment 1 of the present invention. Referring to FIG. 6, the organic EL panel module 11 includes a pixel array section 21, and a pair of sampling scan drivers 23, a pair of power supply scan drivers 25, a horizontal selector 27 and a timing generator (TG) 29 which serve as driving circuits for the pixel array section 21.

The pixel array section 21 includes a large number of sub pixels formed from an organic EL element and a pixel circuit and arranged in a matrix. Incidentally, a sub pixel is a minimum unit of a pixel structure which forms one pixel, and one pixel as a white unit is composed of three sub pixels (R, G, B) of different organic EL materials.

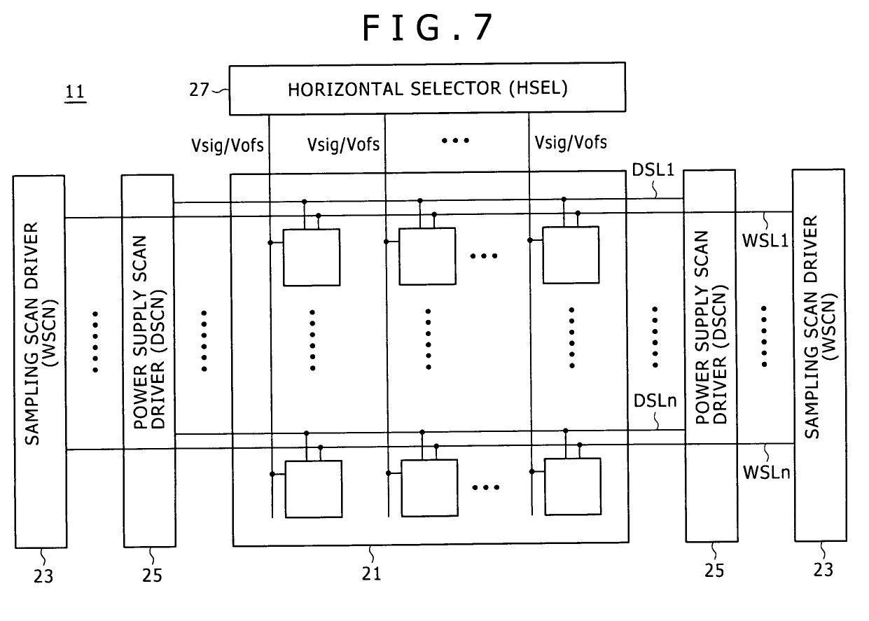

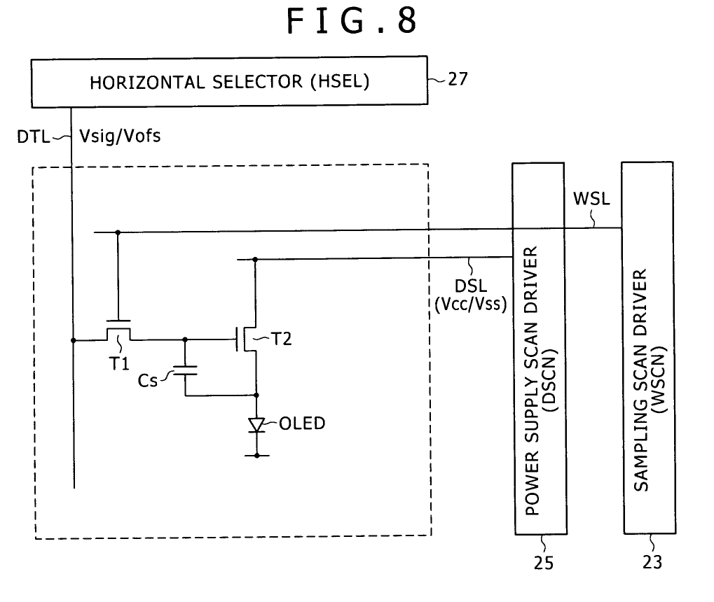

FIG. 7 illustrates a connection relationship between a pixel circuit corresponding to a sub pixel and the driving circuits. FIG. 8 shows an internal configuration of a pixel circuit proposed by the present embodiment. Also the pixel circuit shown in FIG. 8 is composed of two thin film transistors T1 and T2 and one storage capacitor Cs.

It is to be noted that the driving transistor T2 in the pixel circuit is an n-channel thin film transistor. Meanwhile, the storage capacitor Cs is connected to the gate electrode of the driving transistor T2 and the anode electrode of an organic EL element OLED.

Also in the circuit configuration described, the sampling scan drivers 23 control the sampling transistor T1 between on and off through a sampling scan line WSL to control writing of a potential into the storage capacitor Cs. The sampling scan drivers 23 are formed from a shift register.

The power supply scan drivers 25 control the power supply voltage to be applied to one of main electrodes of the driving transistor T2 in a binary fashion through a feed line DSL to control a correction operation of the characteristic dispersion of the pixel circuit together with the other driving circuits. In particular, the power supply scan drivers 25 compensate for the deterioration of the uniformity arising from a threshold value dispersion or a mobility dispersion of the driving transistor T2.

The horizontal selector 27 is a circuit device for applying a signal potential Vsig corresponding to a gradation value of pixel data or an offset voltage Vofs for threshold value correction to a signal line DTL.

The timing generator 29 is a circuit device for producing a driving pulse for the sampling scan line WSL, feed line DSL and signal line DTL.

### B-2. Example of Driving Operation

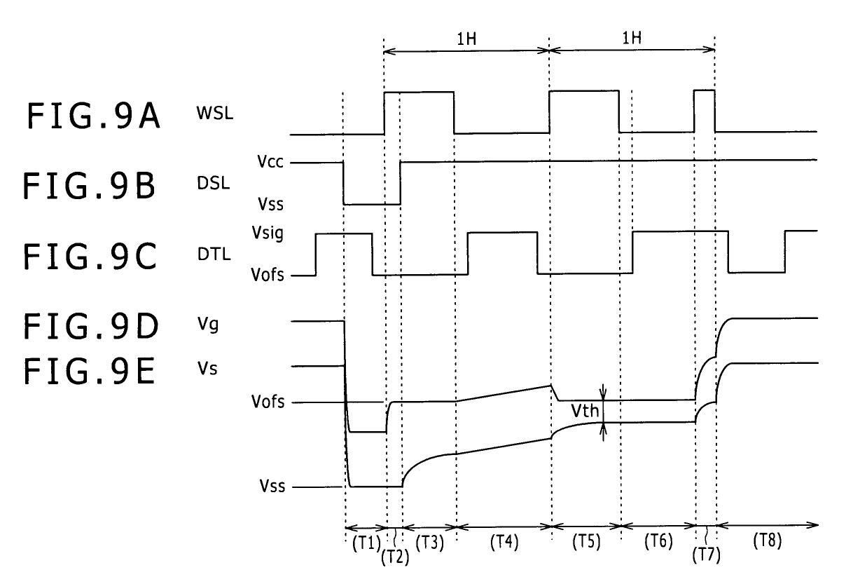

FIGS. 9A to 9E illustrate an example of driving operation of the pixel circuit shown in FIG. 8. It is to be noted that, while FIGS. 9A to 9E illustrate an example of driving operation where two horizontal scanning periods are utilized to execute threshold value correction, operation from a threshold value correction operation to writing of the signal potential Vsig may be executed within one horizontal scanning period.

Incidentally, in FIGS. 9A to 9E, the higher one of two potentials to be applied to the feed line DSL is represented by Vcc while the lower one of the two potentials is represented by Vss.

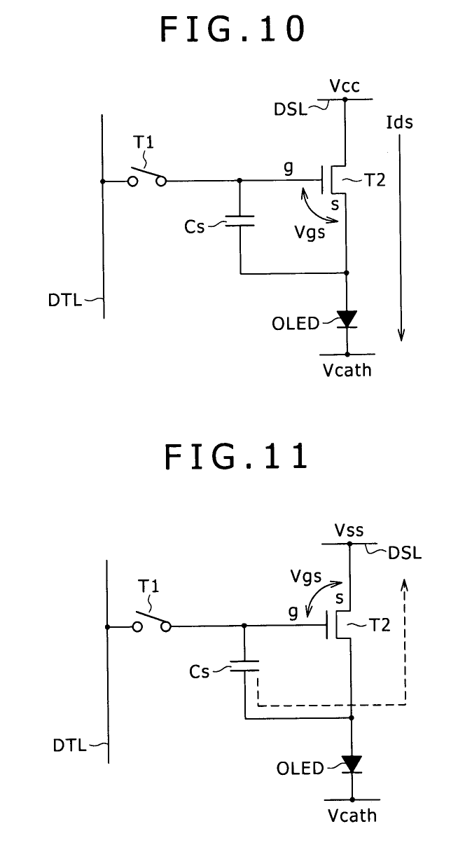

First, an operation state of the pixel circuit in a light emitting state is illustrated in FIG. 10. At this time, the sampling transistor T1 is in an off state. On the other hand, the driving transistor T2 operates in a saturation region, and current Ids which depends upon the gate-source voltage Vgs flows through the driving transistor T2.

Now, an operation state in a no-light emitting state is described. First, the potential of the feed line DSL is changed over from the high potential Vcc to the low potential Vss at time T1 illustrated in FIGS. 9A to 9E. In this instance, if the low potential Vss is lower than the sum of a threshold value Vthel and a cathode potential Vcath, that is, if Vss<Vthel+Vcath, then the organic EL element OLED emits no light.

It is to be noted that the source potential Vs of the driving transistor T2 is equal to the potential of the feed line DSL. In other words, the anode potential of the organic EL element OLED is charged to the low potential Vss. An operation state of the pixel circuit in this instance is illustrated in FIG. 11.

Thereafter, if the potential of the sampling scan line WSL changes to the high potential in a state wherein the potential of the signal line DTL is the offset voltage Vofs for threshold value correction, then the gate potential Vg of the driving transistor T2 changes to the offset voltage Vofs through the sampling transistor T1 in an on state at time T2 illustrated in FIGS. 9A to 9E.

FIG. 12 illustrates the operation state of the pixel circuit in this instance. Thereupon, the gate-source voltage Vgs of the driving transistor T2 is given by Vofs−Vss. This voltage is set so as to be higher than the threshold voltage Vth of the driving transistor T2. This is because the threshold value correction operation cannot be executed if Vofs−Vss>Vth is not satisfied.

Then, the potential of the feed line DSL is changed back to the high potential Vcc at time T3 illustrated in FIGS. 9A to 9E. Since the voltage of the feed line DSL changes to the high potential Vcc, the anode potential of the organic EL element OLED becomes the source potential Vs of the driving transistor T2.

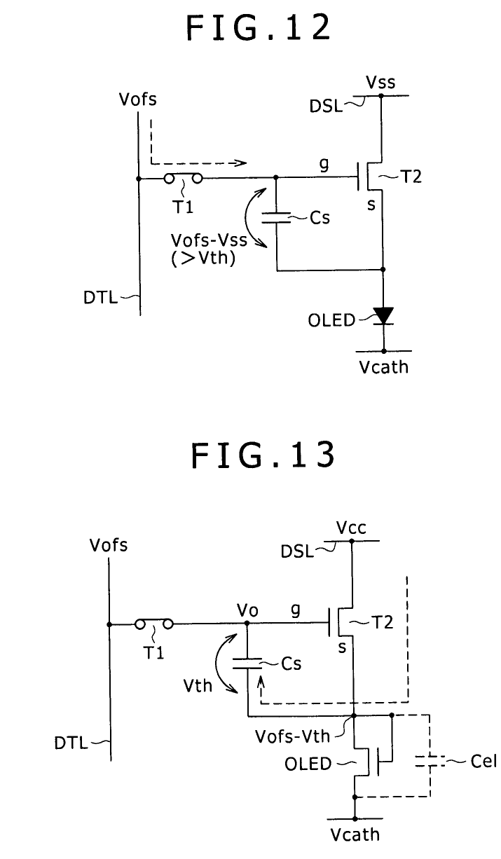

FIG. 13 represents the organic EL element OLED in an equivalent circuit. Referring to FIG. 13, the organic EL element OLED is represented by a diode and a parasitic capacitance Cel. At this time, as far as the relationship of Vel≦Vcath+Vthel is satisfied, the current Ids flowing to the driving transistor T2 is used to charge the storage capacitor Cs and the parasitic capacitance Cel. In this instance, it is assumed that the leak current of the organic EL element is considerably lower than the current Ids flowing through the driving transistor T2.

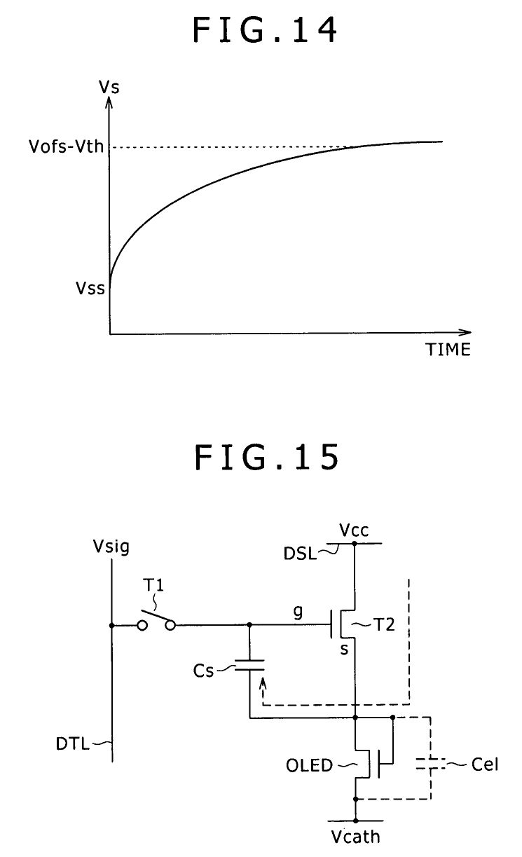

As a result, the anode voltage Vel of the organic EL element OLED rises as time passes as shown in FIG. 14. This period is a threshold value correction period.

After a fixed period of time passes after the threshold value correction period is started, the sampling transistor T1 is controlled to an off state at time T4 illustrated in FIGS. 9A to 9E. In other words, the threshold value correction operation temporarily stops. At this time, the gate-source voltage Vgs of the driving transistor T2 is higher than the threshold voltage Vth.

Accordingly, the current Ids flows and both of the gate potential Vg and the source potential Vs of the driving transistor T2 rise together as seen in FIG. 15. It is to be noted that, also within this period, since a reverse bias is applied to the organic EL element OLED, the organic EL element OLED does not emit light.

Soon, the threshold value correction period is resumed. In particular, the potential of the signal line DTL becomes the offset voltage Vofs and the sampling transistor T1 is controlled to an on state simultaneously at time T5 illustrated in FIGS. 9A to 9E.

Finally, the gate-source voltage Vgs of the driving transistor T2 converges to the threshold voltage Vth. At this time, Vel=Vofs−Vth<Vcath+Vthel is satisfied.

When the threshold value correction period ends, the sampling transistor T1 is controlled to an off state at time T6 illustrated in FIGS. 9A to 9E.

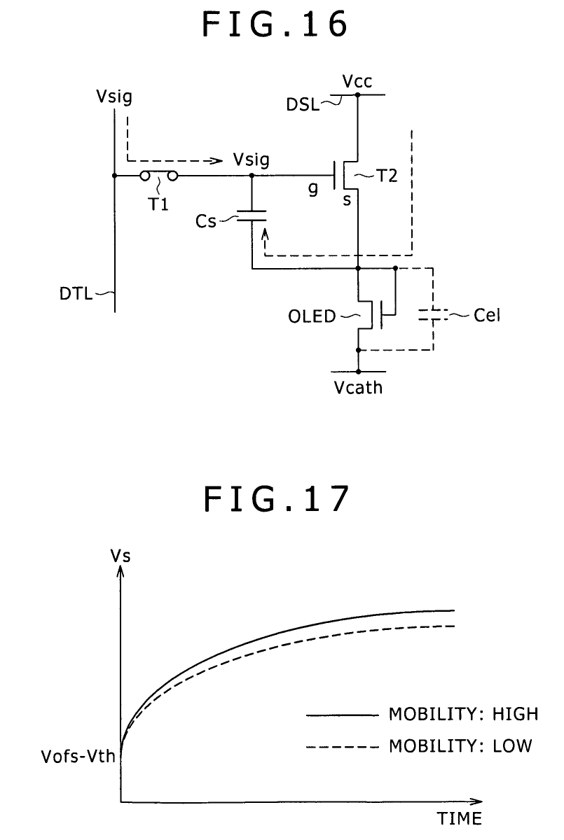

Thereafter, at a point of time when the potential of the signal line DTL becomes the signal potential Vsig, the sampling transistor T1 is controlled back to an on state at time T7 illustrated in FIGS. 9A to 9E. FIG. 16 illustrates an operation state of the pixel circuit in this instance. Incidentally, the signal potential Vsig is fixed depending on the gradation. Thereupon, although the gate potential Vg of the driving transistor T2 becomes the signal potential Vsig, since current from the feed line DSL flows into the storage capacitor Cs and the parasitic capacitance Cel of the organic EL element OLED, the source potential Vs rises as time passes.

At this time, if the source potential Vs of the driving transistor T2 does not exceed the sum of the threshold value Vthel and the cathode potential Vcath of the organic EL element OLED, that is, if the leak current of the organic EL element OLED is considerably lower than the current flowing through the driving transistor T2, then the current Ids of the driving transistor T2 is used to charge the storage capacitor Cs and the parasitic capacitance Cel.

It is to be noted that, since the threshold value correction operation of the driving transistor T2 is completed already, the current Ids supplied by the driving transistor T2 has a value which represents the mobility μ. In particular, as the driving transistor has a higher mobility μ, the current amount increases and the source potential Vs rises more quickly. On the contrary, as the driving transistor has a lower mobility μ, the current amount decreases and the rise of the source potential Vs becomes slower as seen from FIG. 17.

Consequently, the gate-source voltage Vgs of the driving transistor T2 decreases reflecting the mobility p. As a result, at a point of time when a fixed period of time elapses, the gate-source voltage Vgs of the driving transistor T2 converges to a voltage corrected with the mobility μ.

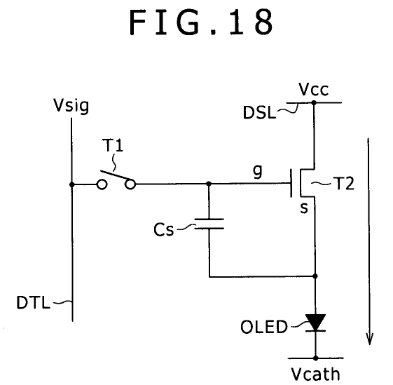

Finally, when the sampling transistor T1 is controlled to an off state and the writing of the signal potential ends, a light emitting period of the organic EL element OLED is started at time T8 illustrated in FIGS. 9A to 9E. FIG. 18 illustrates an operation state of the pixel circuit in this instance. It is to be noted that the gate-source voltage Vgs of the driving transistor T2 is fixed. Accordingly, the driving transistor T2 supplies fixed current Ids' to the organic EL element OLED.

Together with this, the anode voltage Vel of the organic EL element OLED rises to a potential Vx at which the current Ids' is supplied to the organic EL element OLED. Consequently, light emission by the organic EL element OLED is started.

It is to be noted that, also in the case of the driving circuit proposed by the present embodiment, as the light emission time becomes longer, the I-V characteristics thereof varies.

Therefore, also the source potential Vs of the driving transistor T2 varies. However, since the gate-source voltage Vgs of the driving transistor T2 is kept fixed by the storage capacitor Cs, the amount of current flowing through the organic EL element OLED does not vary. In this manner, even if the I-V characteristic of the organic EL element OLED is deteriorated, the fixed current Ids normally continues to flow, and the luminance of the organic EL element OLED does not vary.

### B-3. Summary

If the pixel circuit of the configuration according to the present embodiment described above is adopted, then also where the driving transistor T2 is formed from a thin film transistor of the n channel type, an organic EL panel module wherein the luminance does not disperse among individual pixels can be implemented.

### C. Embodiment 2

Here, a technique for reducing the cost by reduction of the number of signal lines and consequent reduction of the number of driving stages of a horizontal selector is described. In particular, a technique wherein one signal line is used commonly by two pixels positioned adjacent each other on the same horizontal line is described. However, it is presupposed that signal potentials Vsig corresponding to the pixels are different from each other. Accordingly, writing of the signal potentials Vsig into the pixels is executed time-sequentially within the same period after a threshold value correction period ends.

### C-1. System Configuration

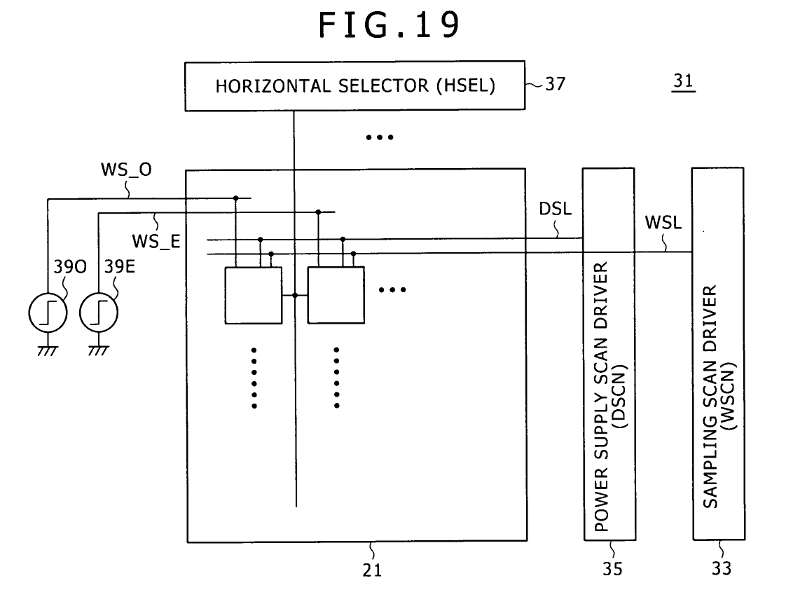

FIG. 19 shows a general system configuration of an organic EL panel module 31 according to an embodiment 2 of the present invention.

Referring to FIG. 19, the organic EL panel module 31 shown includes a pixel array section 21, and a sampling scan driver 33, a power supply scan driver 35, a horizontal selector 37 and a pair of pulse power supplies 39O and 39E which are driving circuits for the pixel array section 21.

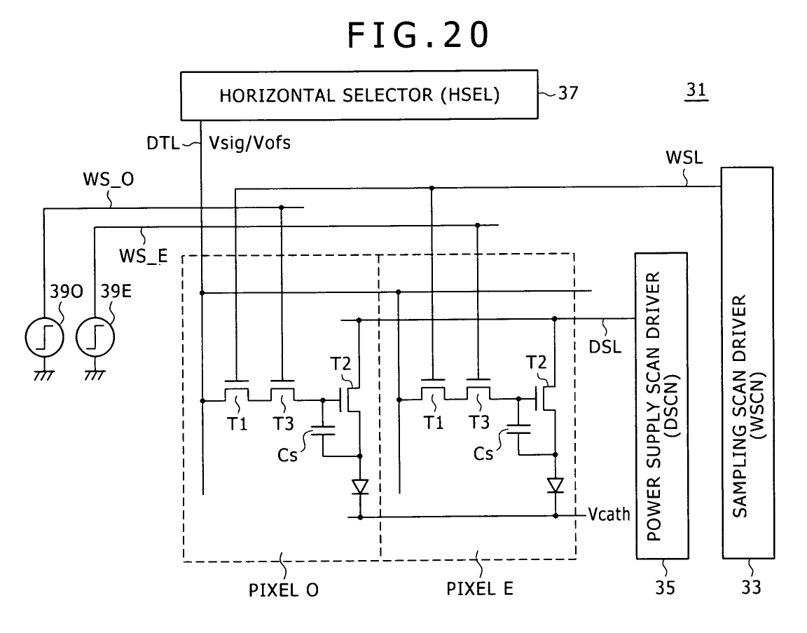

FIG. 20 illustrates a connection relationship between the pixel circuits which compose the pixel array section 21 and wiring lines. In particular, FIG. 20 illustrates a connection relationship where two pixels positioned adjacent each other on the same horizontal line are connected commonly to a signal line DTL. It is to be noted that, in FIG. 20, from among all pixels which compose the pixel array section 21, a pixel positioned at an odd-numbered position on a horizontal line is denoted by “pixel O” while another pixel positioned at an even-numbered position on a horizontal line is denoted by “pixel E.”

In the present embodiment, each pixel circuit includes a first sampling transistor T1, a second sampling transistor T3, a driving transistor T2 and a storage capacitor Cs. In particular, the second sampling transistor T3 is connected in series between the first sampling transistor T1 and the driving transistor T2. It is to be noted that the transistors mentioned are all n-channel thin film transistors.

The first sampling transistor T1 operates at a sampling timing common to all pixels which belong to one horizontal line similarly as in the embodiment 1.

Meanwhile, the driving transistor T2 supplies current Ids based on a gate-source voltage Vgs which depends upon the stored voltage of the storage capacitor Cs to the organic EL element OLED.

Meanwhile, the second sampling transistor T3 operates at a sampling timing determined in response to the pixel position in the horizontal line. For example, the second sampling transistor T3 in a pixel O which is positioned at an odd-numbered position on a horizontal line operates with a sampling scan signal for an odd-numbered pixel group.

On the other hand, the second sampling transistor T3 in a pixel E positioned at an even-numbered position on the horizontal line operates with a sampling scan signal for an even-numbered pixel group. The two sampling transistors T3 are connected in series and are driven and controlled independently of each other so that, even where two different signal potentials Vsig are applied time-sequentially to one signal line DTL, only the signal potentials Vsig for the individual pixels can be taken into the individual pixel circuits.

The sampling scan driver 33 controls the first sampling transistor T1 between on and off through a sampling scan line WSL to control writing of a potential into the storage capacitor Cs. Incidentally, the sampling scan driver 33 is formed from a shift register having a number of stages equal to the vertical resolution.

The power supply scan driver 35 controls the potential of a power supply line DSL, which is applied to one of main electrodes of the driving transistor T2 through the power supply line DSL, in a binary fashion to control a correction operation against a characteristic dispersion in the pixel circuit together with the other driving circuits. In particular, the power supply scan driver 35 corrects against the deterioration in uniformity based on a threshold value dispersion or a mobility dispersion of the driving transistor T2.

The horizontal selector 37 is a circuit device for applying the signal potential Vsig corresponding to a gradation value of pixel data or the offset voltage Vofs for threshold value correction to the signal line DTL. In the present embodiment, the number of signal lines may be one half the horizontal resolution. As a result, reduction of the circuit scale of the horizontal selector 37 and reduction of the driving clock can be implemented. Therefore, the fabrication cost can be reduced.

The pulse power supplies 39O and 39E are signal sources for generating a pulse signal as a mask signal for the first sampling scan signal. In particular, the power supply voltage 390 generates a mask signal for sampling only pulses for the odd-numbered pixel group from within the sampling scan signal supplied from the sampling scan driver 33.

Meanwhile, the power supply voltage 39E generates a mask signal for sampling out only pulses for the even-numbered pixel group from within the sampling scan signal supplied from the sampling scan driver 33.

It is to be noted that each of the pulse power supplies 39O and 39E is disposed one for all pixels of the pixel array section 21. However, each of the pulse power supplies 39O and 39E may otherwise be provided one for each one horizontal scanning line or one for each plural number of horizontal scanning lines.

Besides, different from a scanner or a driver, the pulse power supplies 39O and 39E only generate a timing pulse simply, and therefore, the circuit scale is small.

Further, the organic EL panel module 31 incorporates a timing generator not shown. The timing generator generates a driving pulse for the sampling scan lines WSL, feed lines DSL and signal lines DTL similarly as in the embodiment 1.

### C-2. Example of Driving Operation

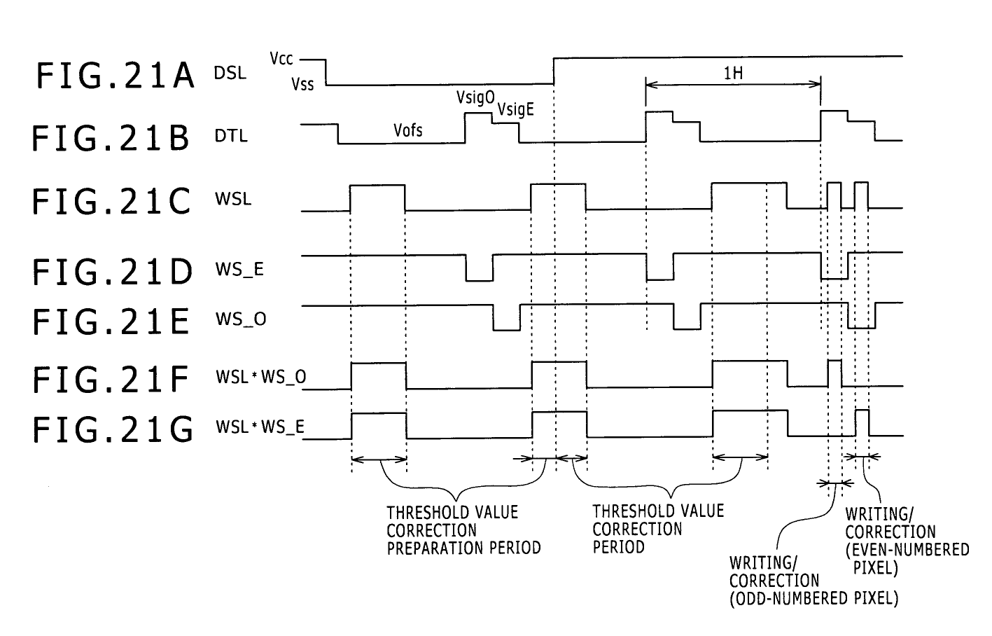

FIGS. 21A to 21G illustrate an example of basic operation of the present embodiment. In particular, FIGS. 21A to 21G illustrate basic operation where writing of the signal potential Vsig corresponding to an even-numbered pixel is executed subsequently to writing of the signal potential Vsig corresponding to an odd-numbered pixel.

Incidentally, FIG. 21A illustrates a pulse waveform of the power supply line DSL. FIG. 21B illustrates a signal waveform of the signal line DTL. Incidentally, within a threshold value correction preparation period, the offset voltage Vofs is applied, but within a writing period of the signal potential Vsig, the signal potentials VsigO and VsigE corresponding to an odd-numbered pixel and an even-numbered pixel are applied.

It is to be noted that FIGS. 21A to 21G illustrate not only a writing period of the signal potential Vsig corresponding to a horizontal line which is noticed in FIGS. 21A to 21G but also writing periods of the signal potential Vsig corresponding to a preceding horizontal line and a second preceding horizontal line.

FIG. 21C illustrates a pulse waveform of the first sampling scan line common to all pixels on the horizontal line. Meanwhile, FIGS. 21D and 21E illustrate pulse waveforms of the second sampling scan lines corresponding to the odd-numbered pixels and the even-numbered pixels on the horizontal line.

FIGS. 21F and 21G illustrate logical AND waveforms of pulse waveforms of the first and second sampling scan lines. Naturally, FIG. 21F corresponds to the odd-numbered pixels and FIG. 21G corresponds to the even-numbered pixels. As seen from FIGS. 21F and 21G, the quite same operation is executed for both of the odd-numbered pixels and the even-numbered pixels before completion of a threshold value correction operation.

Then, only the writing periods of the signal potential VsigO corresponding to the odd-numbered pixel group and the signal potential VsigE corresponding to the even-numbered pixel group are time-sequentially set separately from each other by the masking effect by the second sampling scan signal.

Particularly as regards the even-numbered pixel group, also after writing of the signal potential Vsig for the odd-numbered pixel group is started, a state wherein the threshold value correction operation is completed is maintained.

It is to be noted that, where a pixel structure which does not use the second sampling transistor T3 as in the present embodiment is used, mobility correction is started with a signal potential written first, that is, with the signal potential VsigO to the odd-numbered pixel group, and this disables normal mobility correction upon original writing of the signal potential VsigE.

However, in the case of the present embodiment, since a logical AND gate is formed from a series connection of the first and second sampling transistors T1 and T3 as described hereinabove, the writing/mobility correction periods for the odd-numbered pixel group and the even-numbered pixel group can be separated from each other. As a result, not only the odd-numbered pixel group but also the even-numbered pixel group can use individually corresponding signal potentials Vsig to execute mobility correction.

### C-3. Summary

As described above, in the organic EL panel module 31 according to the embodiment 2, the number of signal lines necessary for driving the pixel array section 21 can be reduced to one half without increasing the number of scanners or drivers each formed from a shift register or the number of processing stages.

By the reduction of the number of signal lines to one half, the number of processing stages of the horizontal selector 37 can be reduced to one half, and the fabrication cost can be reduced as much. It is to be noted that, although the pulse power supplies 39O and 39E are required newly, they may individually provided one, that is, totally two, for the pixel array section 21, and the increase of the cost is very small.

As a result, reduction of the cost of the entire organic EL panel module is implemented.

Naturally, since mobility correction for the pixels is executed accurately, good picture quality free from luminance dispersion in a screen image can be implemented.

### D. Other Embodiments

### D-1. Other Driving Operation

In the embodiment 2 described above, the two pulse waveforms which provide timings of turning on operations of the sampling transistors T3 which compose an odd-numbered pixel and an even-numbered pixel are provided by the first sampling scan signal (FIG. 21C) and one pulse waveform is extracted by each of the second sampling scan signals (FIGS. 21D and 21E).

However, if a timing at which the first sampling transistor T1 and the second sampling transistor T3 carry out turning on operation at the same time is provided, then a pulse waveform for the odd-numbered pixel group and a pulse waveform for the even-numbered pixel group can be separated from reach other. Therefore, The relationship of the pulse waveform which provides a writing and mobility correction period for the signal potential Vsig may be reverse to each other between the first sampling scan signal and the second sampling scan signals.

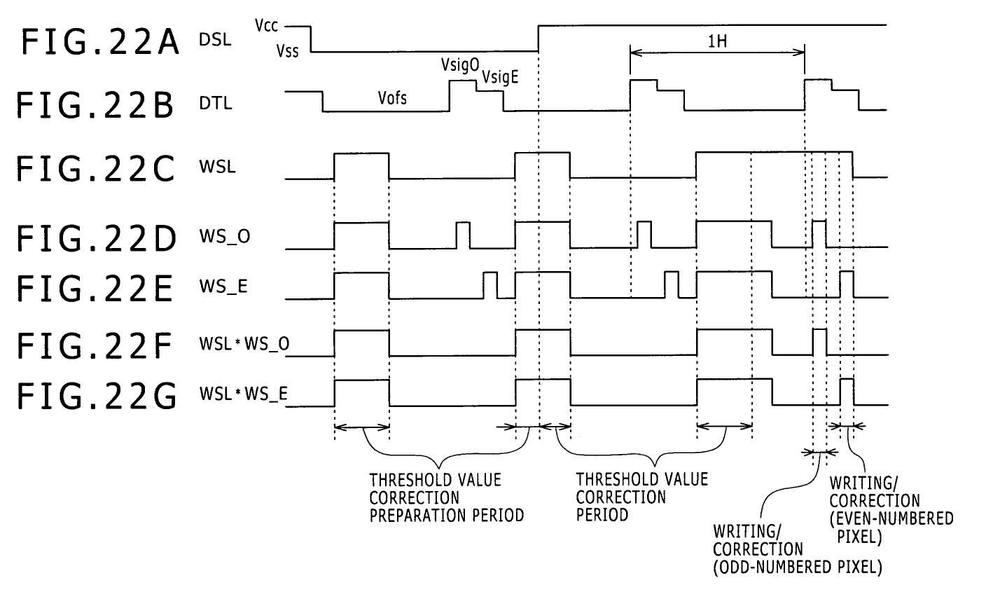

FIGS. 22A to 22G illustrate an example of signal waveforms of the type described. It is to be noted that the waveforms of FIGS. 22A to 22G correspond to the waveforms of FIGS. 21A to 21G, respectively, and the signal waveforms other than the signal waveforms of FIGS. 21B and 22B representing the first sampling scan signal waveforms and the signal waveforms of FIGS. 21C, 21D and 22C, 22D representing the second sampling scan signal waveforms are same as each other.

In the case of FIGS. 22A to 22G, the first sampling scan signal functions as a kind of write enable signal such that, only when the second sampling scan signal is in an on state, the signal potential Vsig corresponding to each pixel group is written into the storage capacitor Cs.

### D-2. Different Panel Structure 1

In the embodiment described above, one signal line is used commonly by pixels at odd-numbered positions and pixels at even-numbered positions on the same horizontal line.

However, one signal line may otherwise be used commonly by three or more pixels which are positioned on the same horizontal line.

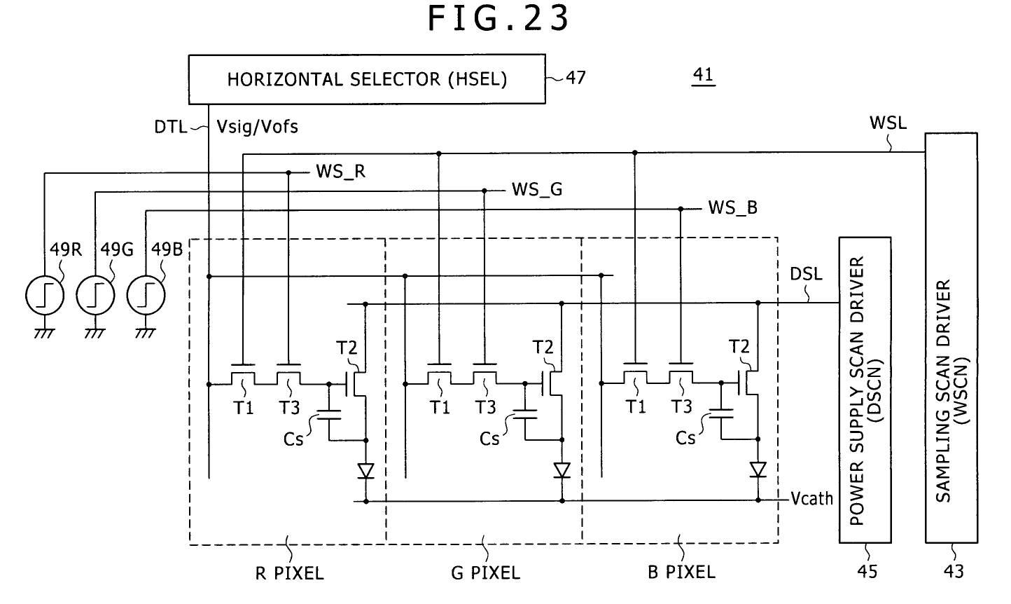

FIG. 23 illustrates a connection relationship between pixel circuits where the pixel array includes R pixels, G pixels and B pixels and wiring lines. Referring to FIG. 23, the organic EL panel module 41 shown includes a pixel array section 21, and a sampling scan driver 43, a power supply scan driver 45, a horizontal selector 47 and three pulse power supplies 49R, 49G and 49B, which are driving circuits for the pixel array section 21. In FIG. 23, only one R pixel, one G pixel and one B pixel are shown in the pixel array section 21.

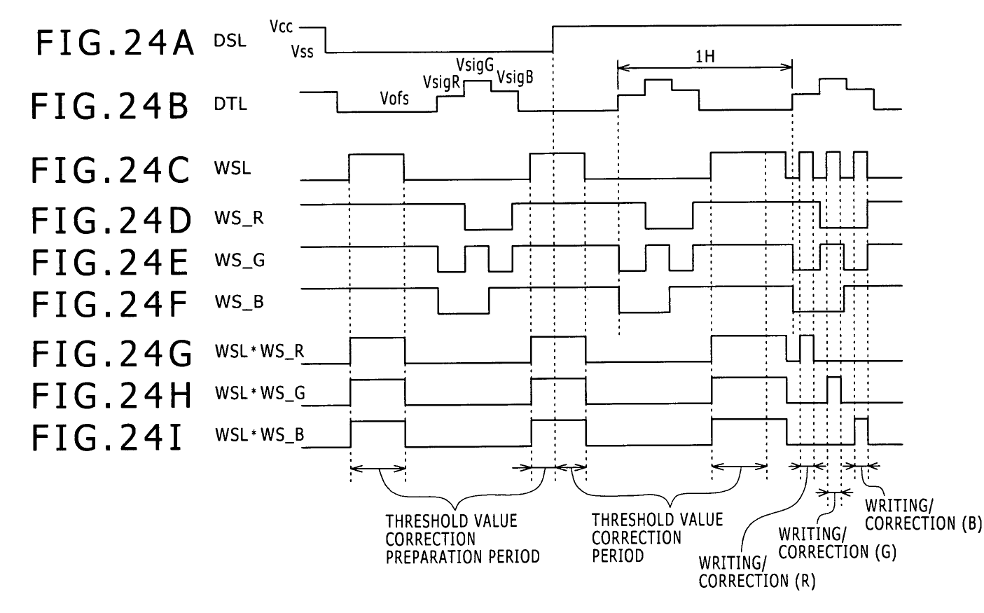

Driving operation of the organic EL panel module 41 is illustrated in FIGS. 24A to 24I. Also in this instance, each of the pixel circuits includes first and second sampling transistors T1 and T3. Therefore, by controlling the timing at which the first sampling scan signal and the second sampling scan signals are controlled to an on state at the same time, the signal potentials VsigR, VsigG and VsigB corresponding to the individual light colors can be written only into corresponding pixel circuits, and mobility correction can be carried out simultaneously by driving current flowing thereupon.

### D-3. Different Panel Structure 2

In the embodiment described above, one signal line is used commonly to a plurality of pixel circuits positioned on the same horizontal line. However, the embodiment of the present invention can be applied also where one signal line is used commonly to a plurality of pixel circuits positioned on a plurality of horizontal lines and the signal potentials corresponding to the individual pixel circuits are applied time-sequentially to one signal line DTL.

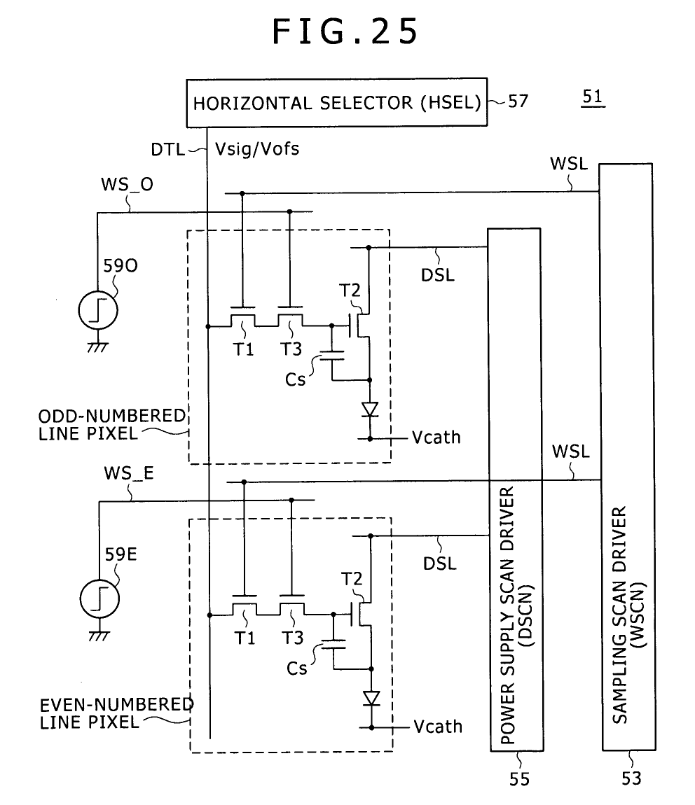

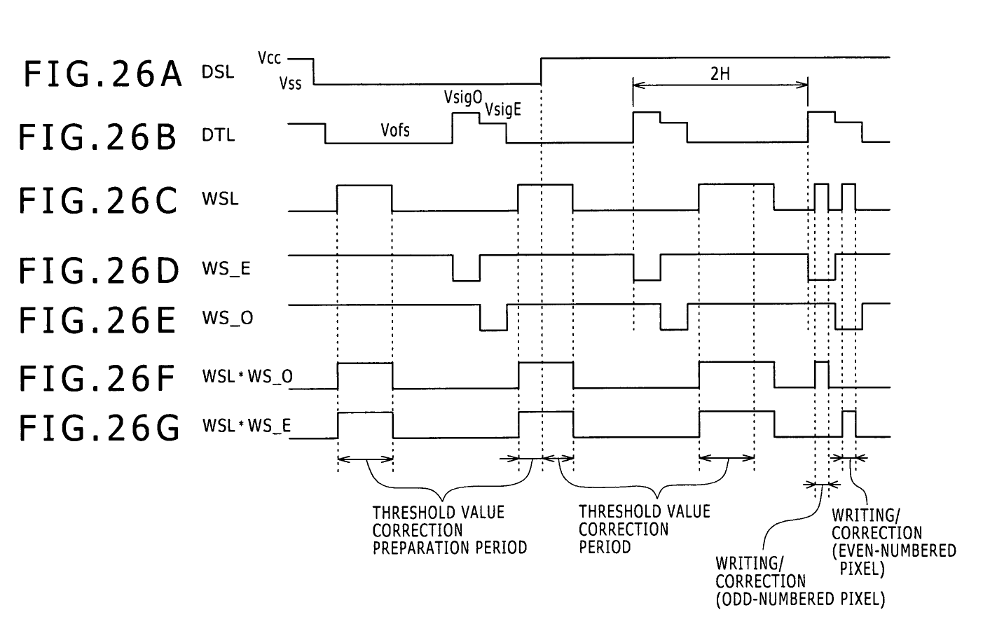

FIG. 25 illustrates a connection relationship between pixel circuits and wiring lines where writing of the signal potential Vsig and mobility correction are executed time-sequentially within the same period between an odd-numbered horizontal line and an even-numbered horizontal line.

It is to be noted that an organic EL panel module 51 shown in FIG. 25 includes a pixel array section 21, and a sampling scan driver 53, a power supply scan driver 55, a horizontal selector 57 and a pair of pulse power supplies 59O and 59E, which are driving circuits for the pixel array section 21. In FIG. 25, only a pixel on an odd-numbered horizontal line and another pixel on an even-numbered horizontal line are shown in the pixel array section 21.

In the case of the present panel structure, writing of the signal potential Vsig into the pixel circuits is executed in a unit of two horizontal scanning periods. Incidentally, in the case of the embodiment 1, such writing is executed in a unit of one horizontal scanning period. In particular, in the present panel structure, a threshold value correction operation and writing of a signal potential are executed in a unit of two horizontal lines. In this instance, the potential of the signal line DTL is applied time-sequentially within the same period as the signal potentials Vsig for the odd-numbered line and the even-numbered line.

Also by this, such a situation can be prevented effectively that, if the technique described is not adopted, then mobility correction for the signal potential VsigO for the even-numbered line is started upon application of a signal potential for the odd-numbered line and, upon writing of the original signal potential VsigE, mobility correction is not carried out accurately.

While the case is described above wherein writing of the signal potential Vsig is executed time-sequentially within the same period between two horizontal lines, the embodiment of the present invention can be applied also where a writing period is used commonly for three or more periods.

### D-4. Examples of a Product

a. Electronic Apparatus

In the embodiments described above, the present invention is applied to an organic EL panel module. However, the organic EL panel module is distributed also in the form of a commodity wherein it is incorporated in various electronic apparatus. In the following, various examples wherein the organic EL panel module is incorporated in other electronic apparatus are described.

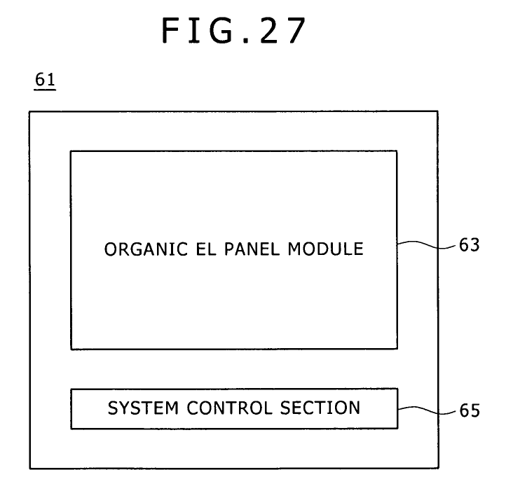

FIG. 27 shows an example of a configuration of an electronic apparatus 61. Referring to FIG. 27, the electronic apparatus 61 includes an organic EL panel module 63 described hereinabove and a system control section 65. The contents of processing executed by the system control section 65 differ depending upon the form of a commodity of the electronic apparatus 61.

It is to be noted that the electronic apparatus 61 is not limited to an apparatus in a particular field only if it incorporates a function of displaying an image produced in the apparatus or inputted from the outside.

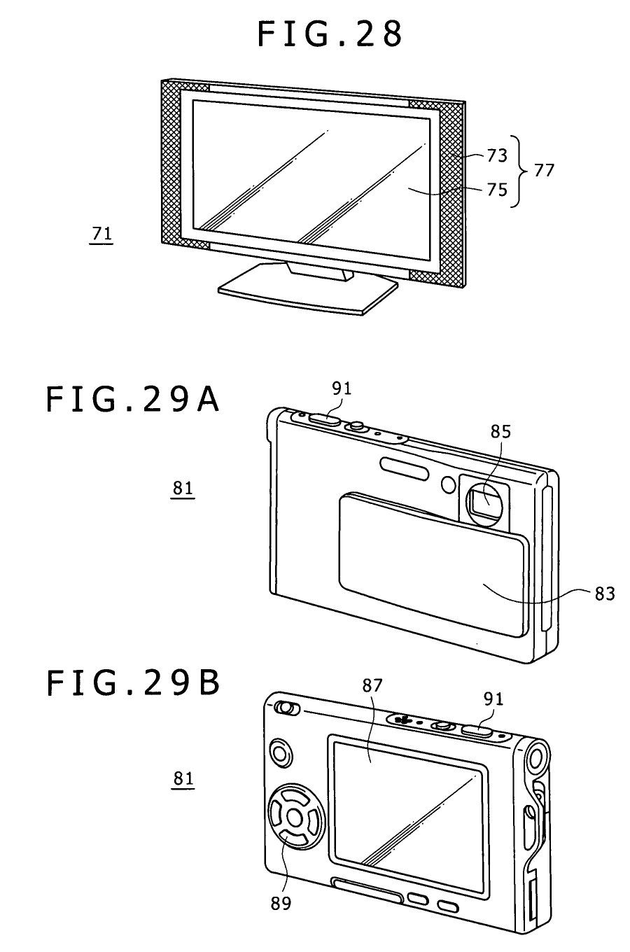

FIG. 28 shows an example of an appearance of an electronic apparatus in the form a television receiver. Referring to FIG. 28, the television receiver 71 includes a display screen 77 provided on the front face of a housing thereof and including a front panel 73, a filter glass plate 75 and so forth. The display screen 77 corresponds to the organic EL panel module of any of the embodiments described hereinabove.

The electronic apparatus 61 may alternatively have a form of, for example, a digital camera. FIGS. 29A and 29B show an example of an appearance of a digital camera 81. In particular, FIG. 29A shows an example of an appearance of the front face side, that is, the image pickup object side, and FIG. 29B shows an example of an appearance of the rear face side, that is, the image pickup person side, of the digital camera 81.

Referring to FIGS. 29A and 29B, the digital camera 81 shown includes a protective cover 83, an image pickup lens section 85, a display screen 87, a control switch 89 and a shutter button 91. The display screen 87 corresponds to the organic EL panel module of any of the embodiments described hereinabove.

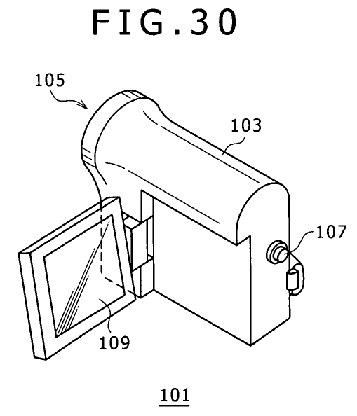

The electronic apparatus 61 may otherwise have a form of, for example, a video camera. FIG. 30 shows an example of an appearance of a video camera 101.

Referring to FIG. 30, the video camera 101 shown includes a body 103, and an image pickup lens 105 for picking up an image of an image pickup object, a start/stop switch 107 for image pickup and a display screen 109, provided at a front portion of the body 103. The display screen 109 corresponds to the organic EL panel module of any of the embodiments described hereinabove.

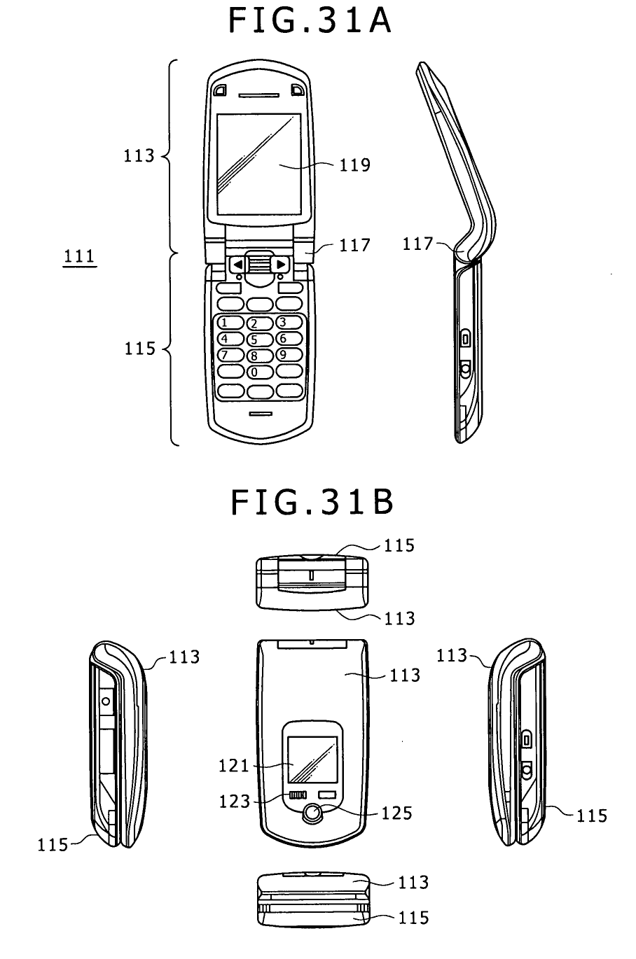

The electronic apparatus 61 may alternatively have a form of, for example, a portable terminal apparatus. FIGS. 31A and 31B show an example of an appearance of a portable telephone set 111 as a portable terminal apparatus. Referring to FIGS. 31A and 31B, the portable telephone set 111 shown is of the foldable type, and FIG. 31A shows an example of an appearance of the portable telephone set 111 in a state wherein a housing thereof is unfolded while FIG. 31B shows an example of an appearance of the portable telephone set 111 in another state wherein the housing thereof is folded.

The portable telephone set 111 includes an upper side housing 113, a lower side housing 115, a connection section 117 in the form of a hinge section, a display screen 119, a sub display screen 121, a picture light 123 and an image pickup lens 125. The display screen 119 and the sub display screen 121 correspond to the organic EL panel module of any of the embodiments described hereinabove.

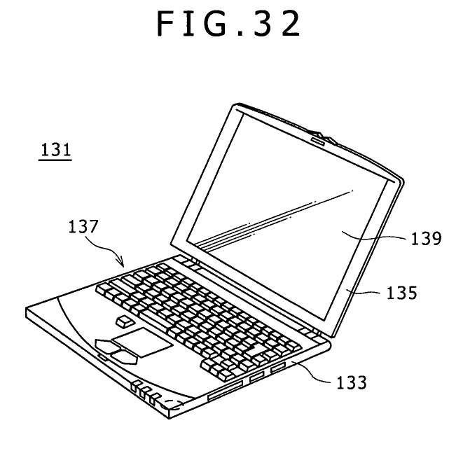

The electronic apparatus 61 may otherwise have a form of, for example, a computer. FIG. 32 shows an example of an appearance of a notebook type computer 131.

Referring to FIG. 32, the notebook type computer 131 shown includes a lower side housing 133, an upper side housing 135, a keyboard 137 and a display screen 139. The display screen 139 corresponds to the organic EL panel module of any of the embodiments described hereinabove.

The electronic apparatus 61 may otherwise have various other forms such as an audio reproduction apparatus, a game machine, an electronic book and an electronic dictionary.

### D-5. Other Examples of a Display Device

In the foregoing description, the present invention is applied to an organic EL panel module.

However, the driving technique described above can be applied also to EL display apparatus of other types. For example, the present invention can be applied also, for example, to a display apparatus wherein a plurality of LEDs (light emitting diodes) are arrayed and another display apparatus wherein a plurality of light emitting elements having some other diode structure are arrayed on a screen.

### D-6. Others

The embodiments described above may be modified in various manners without departing from the spirit and scope of the present invention. Also various modifications and applications may be created or combined based on the disclosure of the present invention.

What is claimed is:

1. An electro luminescence display panel module, comprising:
a pixel array section including
a plurality of pixels disposed in a matrix and each including
a pixel circuit, and
a light emitting region,
a plurality of signal lines extending in a vertical direction, and
a plurality of horizontal lines extending in a horizontal direction,
said signal lines and said horizontal lines being connected to said pixels such that each of said signal lines is connected to N ones of the pixel circuits which are connected to the same one of said horizontal lines, N being a natural number equal to or greater than 2;
a first sampling control line provided in a unit of a horizontal line and connected to all of the pixel circuits connected to the horizontal line;
N second sampling control lines provided for each one of said horizontal lines and connected in a unit of a group to N ones of the pixel circuits connected to each of the signal lines;
a sampling scan driver for line-sequentially driving the first sampling control lines in a unit of a horizontal line;
N pulse power supplies for driving all of the pixel circuits of said pixel array section in a unit of a group through said N second sampling control lines; and
a horizontal selector for time-sequentially applying, upon writing of a signal potential, N signal potentials for the individual signal lines within the same period;
said pixel array section, the first sampling control lines, said N second sampling control lines, said sampling scan driver, said N pulse power supplies and said horizontal selector being mounted on the same substrate.

2. The electro luminescence display panel module according to claim 1, wherein said pixel circuit includes:
a first sampling transistor controlled by an associated one of the first sampling control lines;
a second sampling transistor connected in series to said first sampling transistor and controlled by an associated one of said second sampling control lines; and
a driving transistor electrically connected at the gate thereof to an associated one of said signal lines only when both of said first and second sampling transistors are on, said driving transistor supplying current corresponding to a gate-source voltage thereof stored in a storage capacitor.

3. The electro luminescence display panel module according to claim 1, wherein the group units include:
a group of those of said pixels which are positioned at odd-numbered positions on each of said horizontal lines, and
a group of those of said pixels which are positioned at even-numbered positions on the horizontal line.

4. The electro luminescence display panel module according to claim 1, wherein the group units include a group of R pixels, a group of G pixels and a group of B pixels which cooperatively form white units.

5. An electro luminescence display panel module, comprising:
a pixel array section including
a plurality of pixels disposed in a matrix and each including
a pixel circuit, and
a light emitting region,
a plurality of signal lines extending in a vertical direction, and
a plurality of horizontal lines extending in a horizontal direction,
said signal lines and said horizontal lines being connected to said pixels such that each of said signal lines is connected to those of the pixel circuits which are connected to different ones of said horizontal lines;
a first sampling control line provided in a unit of a horizontal line and connected to all of the pixel circuits connected to the horizontal line;
N second sampling control lines connected to all of those of the pixel circuits on one of said horizontal lines which corresponds to each of the groups, N being a natural number equal to or greater than 2;
a sampling scan driver for line-sequentially driving the first sampling control lines in a unit of a horizontal line;
N pulse power supplies for driving all of the pixel circuits of said pixel array section in a unit of a group through said N second sampling control lines; and
a horizontal selector for time-sequentially applying, upon writing of a signal potential, N signal potentials for the individual signal lines within the same period;
said pixel array section, the first sampling control lines, said N second sampling control lines, said sampling scan driver, said N pulse power supplies and said horizontal selector being mounted on the same substrate.

6. An electro luminescence display panel, comprising:
a pixel array section including
a plurality of pixels disposed in a matrix and each including
a pixel circuit, and
a light emitting region,
a plurality of signal lines extending in a vertical direction, and
a plurality of horizontal lines extending in a horizontal direction,
said signal lines and said horizontal lines being connected to said pixels such that each of said signal lines is connected to N ones of the pixel circuits which are connected to the same one of said horizontal lines, N being a natural number equal to or greater than 2;
a first sampling control line provided in a unit of a horizontal line and connected to all of the pixel circuits connected to the horizontal line;
N second sampling control lines provided for each one of said horizontal lines and connected in a unit of a group to N ones of the pixel circuits connected to each of the signal lines;
a sampling scan driver for line-sequentially driving the first sampling control lines in a unit of a horizontal line; and
a horizontal selector for time-sequentially applying, upon writing of a signal potential, N signal potentials for the individual signal lines within the same period;
said pixel array section, the first sampling control lines, said N second sampling control lines, said sampling scan driver, said N pulse power supplies and said horizontal selector being formed on the same substrate.

7. An electro luminescence display panel, comprising:
a pixel array section including
a plurality of pixels disposed in a matrix and each including
a pixel circuit, and
a light emitting region,
a plurality of signal lines extending in a vertical direction, and
a plurality of horizontal lines extending in a horizontal direction,
said signal lines and said horizontal lines being connected to said pixels such that each of said signal lines is connected to those of the pixel circuits which are connected to different ones of said horizontal lines;
a first sampling control line provided in a unit of a horizontal line and connected to all of the pixel circuits connected to the horizontal line;
N second sampling control lines connected to all of those of the pixel circuits on one of said horizontal lines which corresponds to each of the groups, N being a natural number equal to or greater than 2;
a sampling scan driver for line-sequentially driving the first sampling control lines in a unit of a horizontal line; and
a horizontal selector for time-sequentially applying, upon writing of a signal potential, N signal potentials for the individual signal lines within the same period;
said pixel array section, the first sampling control lines, said N second sampling control lines, said sampling scan driver, said N pulse power supplies and said horizontal selector being mounted on the same substrate.

8. An electronic apparatus, comprising:
a pixel array section including
a plurality of pixels disposed in a matrix and each including
a pixel circuit, and
a light emitting region,
a plurality of signal lines extending in a vertical direction, and
a plurality of horizontal lines extending in a horizontal direction,
said signal lines and said horizontal lines being connected to said pixels such that each of said signal lines is connected to N ones of the pixel circuits which are connected to the same one of said horizontal lines, N being a natural number equal to or greater than 2;
a first sampling control line provided in a unit of a horizontal line and connected to all of the pixel circuits connected to the horizontal line;
N second sampling control lines provided for each one of said horizontal lines and connected in a unit of a group to N ones of the pixel circuits connected to each of the signal lines;
a sampling scan driver for line-sequentially driving the first sampling control lines in a unit of a horizontal line;
N pulse power supplies for driving all of the pixel circuits of said pixel array section in a unit of a group through said N second sampling control lines;
a horizontal selector for time-sequentially applying, upon writing of a signal potential, N signal potentials for the individual signal lines within the same period;
a system control section for controlling said sampling scan driver, N pulse power supplies and horizontal selector; and
an operation inputting section for inputting an operation to said system control section.

9. An electronic apparatus, comprising:
a pixel array section including
a plurality of pixels disposed in a matrix and each including
a pixel circuit, and
a light emitting region,
a plurality of signal lines extending in a vertical direction, and
a plurality of horizontal lines extending in a horizontal direction,
said signal lines and said horizontal lines being connected to said pixels such that each of said signal lines is connected to those of the pixel circuits which are connected to different ones of said horizontal lines;
a first sampling control line provided in a unit of a horizontal line and connected to all of the pixel circuits connected to the horizontal line;
N second sampling control lines connected to all of those of the pixel circuits on one of said horizontal lines which corresponds to each of the groups, N being a natural number equal to or greater than 2;
a sampling scan driver for line-sequentially driving the first sampling control lines in a unit of a horizontal line;
N pulse power supplies for driving all of the pixel circuits of said pixel array section in a unit of a group through said N second sampling control lines;
a horizontal selector for time-sequentially applying, upon writing of a signal potential, N signal potentials for the individual signal lines within the same period;
a system control section for controlling said sampling scan driver, N pulse power supplies and horizontal selector; and
an operation inputting section for inputting an operation to said system control section.
